(19) United States
(12) Patent Application Publication
(10) Pub. No.: US 2002/0176553 A1
(43) Pub. Date: Nov. 28, 2002

(54) Procedure for accounting for communication fees

(76) Inventor: Alexander Aschir, Bangalore (IN)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/131,570

(22) Filed: Apr. 25, 2002

(30) Foreign Application Priority Data
Apr. 26, 2001 (EP) 01250147.4

(51) Int. Cl. H04M 15/00; H04M 17/00; H04M 11/00

(52) U.S. Cl. 379/114.2; 379/114.01; 379/114.17; 379/144.01; 455/406

(57) ABSTRACT

The invention relates to a method for invoicing communications charges incurred when using a communications terminal, in which a charge account associated with the communications terminal and at least one supplementary-charge account are used for invoicing charges, the account balance of the charge account or of the supplementary-charge account at the time at which the communications link is set up is evaluated for the respective communications link as a communications link property, and, depending on the occurrence of this communications link property, either the charge account or one of the supplementary-charge accounts is debited with the communications charges.

### CLAIM FOR PRIORITY

This application claims priority of European Application 01250147.4 filed on Apr. 26, 2001.

### TECHNICAL FIELD OF THE INVENTION

The invention relates to a method for invoicing communications charges incurred when using a communications terminal.

### BACKGROUND OF THE INVENTION

Communications charges incurred in connection with the use of a communications terminal are typically debited to a charge account associated with the communications terminal. Depending on the type of charge account and any agreement made between a communications network operator and an owner of the communications terminal, the communications charges (debited to the charge account) may be paid in different ways. This can be done, for example, by direct debit or by money transfer from a bank account. In this case, all charges to be borne on the part of the communications terminal are invoiced using one charge account.

U.S. Pat. No. 6,195,419 B1 discloses a method and an arrangement in which communications charges are invoiced using different accounts. Of these accounts, one account is selected for invoicing on the basis of the respective caller's telephone number and the telephone number of the respective called party.

German laid-open specification DE 43 12 362 A1 discloses a mobile radio network which has an intelligent network structure and in which charging is effected using a credit account.

U.S. Pat. No. 4,776,004 discloses an arrangement and a method for invoicing telecommunications charges using made, a caller selects a sub-account which is to be used for the call by inputting a sub-account number.

European Patent Application EP 1 006 707 A2 discloses a method for invoicing telephone costs using various accounts, where an identification number for the respective account to be used is input before a call.

International Patent Application WO 00/11889 discloses an arrangement and a method for invoicing supplementary charges incurred for telecommunications charges, with these supplementary charges being invoiced using various accounts.

### SUMMARY OF THE INVENTION

The invention discloses a method which allows communications charges to be invoiced flexibly and matched to a respective type of use of the communications terminal.

In one embodiment of the invention, there is a method for invoicing communications charges incurred when using a communications terminal, in which a charge account associated with the communications terminal and at least one supplementary-charge account are used for invoicing charges, the account balance of the charge account or of the supplementary-charge account at the time at which the communications link is set up is evaluated for the respective communications link as a communications link property, and, depending on the occurrence of this communications link property, either the charge account or one of the supplementary-charge accounts is debited with the communications charges.

In one aspect of the invention, there is an advantage that the identification of the occurrence of predetermined communications link properties allows various types of communications links to be distinguished, and the communications charges for the different types of communications links can be debited to different accounts (charge account and one or more supplementary-charge accounts). This permits a very comprehensible type of charge invoicing, and there is no need for any subsequently necessary separation of charges debited to just a single account.

In another embodiment of the invention, the communications link property evaluated is the account balance of the charge account or of the supplementary-charge account at the time at which the communications link is set up. This advantageously allows the account balance of the charge account and the account balances of the supplementary-charge accounts to be taken into consideration when evaluating the communications link property and, hence, when determining the account which is to be used. By way of example, in the event of a prepaid charge account including no more prepaid credit, it is possible to debit a supplementary-charge account for which such debiting is still possible.

In one aspect of the invention, one of the supplementary-charge accounts used is a terminal-specific supplementary-charge account which is associated with the communications terminal.

In still another embodiment of the invention, one of the supplementary-charge accounts used is a supplementary-charge account specific to an external appliance, which account is associated with a terminal other than the communications terminal. This advantageously allows supplementary-charge accounts associated with different communications terminals to be used, which permits differentiated invoicing of the communications charges.

In yet another embodiment of the invention, the charge account debited is a prepaid charge account. With such a prepaid charge account, it is advantageous for the level of charges which can be paid for setting up communications links to be limited by the level of the prepaid credit. This provides cost control. By way of example, this type of charge account may be used, for example, as a preference for children whose parents wish to have cost control over the communications charges incurred by the children.

In still another embodiment of the invention, the supplementary-charge account used is a subsequently debitable supplementary-charge account which is debited when the communications link has been terminated. Such a subsequently debitable charge account is also called a post-paid account. By way of example, it can be used advantageously when the level of communications charges incurred is difficult to estimate in advance, and hence a charge account which can be debited with an unlimited level of communications charges is desired.

In one aspect of the invention, different charge tariffs are used for debiting the charge account and for debiting the supplementary-charge account. This makes it possible for the communications charge tariffs to be matched to the communications link properties and hence to different types of communications links.

In another embodiment of the invention, the debit to the charge account and the debit to the supplementary-charge account may be borne by different cost units. In this context, it is advantageous, by way of example, that different types of communications links can be paid for by different payment centers, so that different types of communications charges may be invoiced to different payment centers. Subsequent complex separation of the communications charges according to different payment centers becomes unnecessary.

In yet another embodiment of the invention, the supplementary-charge account is debited if the communications terminal is used to set up a communications link to a destination communications terminal which belongs to a predetermined selection of destination communications terminals, and the charge account is debited if the communications terminal is used to set up a communications link to other destination communications terminals. In this context, it is particularly advantageous that an appropriately devised predetermined selection of destination communications terminals makes it possible to stipulate which communications charges are debited to the supplementary-charge account. In one example, the predetermined selection can comprise the destination communications terminals which are called from the communications terminal in connection with a work project. The communications charges incurred in this case are then invoiced using the supplementary-charge account set up for the work project in this example.

In yet another embodiment of the invention, when a communications link is set up to the communications terminal from a calling communications terminal which belongs to a predetermined selection of calling communications terminals, the charge account is debited, and when a communications link is set up to the communications terminal from another calling communications terminal, a supplementary-charge account associated with this calling communications terminal is debited. In this case, a particular advantage is that the charge account for the communications terminal is debited with communications charges even if the communications terminal is called from a special calling communications terminal. This means that, even with that type of call, it is possible, by way of example, to use a cheaper tariff which is applied to the charge account. The supplementary-charge account for the calling communications terminal can, by way of example, be that charge account which is normally used for invoicing the calls made from the calling communications terminal.

In one aspect of the invention, the communications link property evaluated is the time at which the communications link is set up. This means that, on the basis of the time of day, the day of the week, the month or the year, or on the basis of the occurrence of public holidays, vacation days or business trip days, for example, it is possible to stipulate whether the communications charges are to be invoiced using the charge account or using one of the supplementary-charge accounts.

In another aspect of the invention, the communications link properties are evaluated by an intelligent node in a communications network having an intelligent network (IN) structure. In this context, it is preferable that an intelligent node can be prepared and used with little complexity in order to implement the inventive method.

### BRIEF DESCRIPTION OF THE DRAWINGS

To explain the invention further,

FIG. 1 shows an exemplary embodiment of an arrangement with a telecommunications network for carrying out the invention.

FIG. 2 shows an exemplary embodiment of an arrangement for carrying out the invention.

### DETAILED DESCRIPTION OF THE PREFERRED EMBODIMENTS

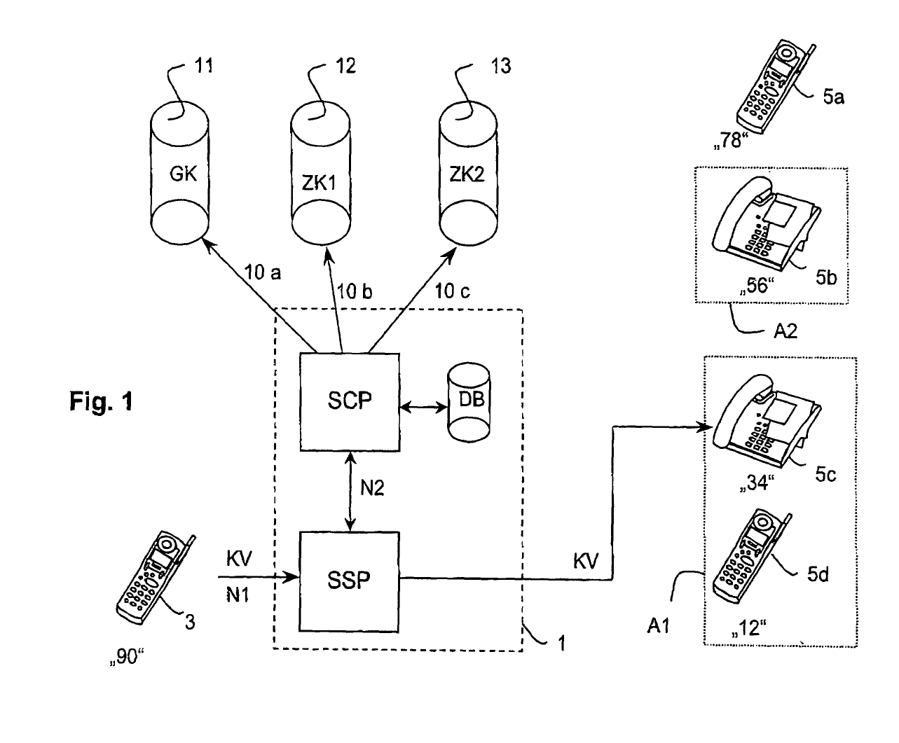

FIG. 1 shows a communications network 1 to which a communications terminal 3 in the form of a mobile telephone is connected. The communications terminal 3 has an address in the form of, by way of example, a call number “90”. Destination communications terminals 5a, 5b, 5c and 5d, to which the communications terminal 3 can connect via the communications network 1, are also shown. The destination communications terminals 5b and 5c are in the form of landline telephones. The destination communications terminals 5a and 5d are in the form of mobile telephones. The various forms of the terminals are to be understood only as an example. However, it is likewise possible, for example, for the terminals used to be computer terminals, portable computers (laptops) or PDAs (Personal Digital Assistants). The destination communications terminals 5c and 5d belong to a first predetermined selection A1 of destination communications terminals, the destination communications terminal 5b forms a second predetermined selection A2 of destination communications terminals, and the destination communications terminal 5a does not belong to predetermined selections of destination communications terminals.

The communications network 1 includes a service switching point SSP as an exchange and includes a service control point SCP as an intelligent node. The communications network 1 thus has a typical structure of an intelligent network (IN=Intelligent Network). The service control point SCP is able to communicate with various account management facilities, i.e. is able to debit accounts with communications charges. Specifically, the account management facilities in the present exemplary embodiment are a first account management facility 11 for a charge account GK, a second account management facility 12 for a supplementary-charge account ZK1 and a third account management facility 13 for a second supplementary-charge account ZK2. The supplementary-charge accounts ZK1 and ZK2 are examples of terminal-specific supplementary-charge accounts associated with the communications terminal 3. The account management facilities 11 to 13 can be arranged outside the communications network 1 and can be connected to the service control point SCP via transmission links 10a , 10b and 10c, as shown in FIG. 1. It is likewise possible, however, for these three account management facilities to be arranged within the communications network. By way of example, they can be implemented on a computer which is also used to implement the service control point SCP. The service control point SCP is connected to a database DB. This database DB stores, by way of example, information relating to the aforementioned first predetermined selection A1 of destination communications terminals and the second predetermined selection A2 of destination communications terminals.

The invention will now be described below by way of example. In this example, the communications terminal 3 will be used by a child whose parents have the destination communications terminals 5c and 5d available. Associated with the communications terminal 3 are the account management facilities 11 to 13 for the charge account GK, the first supplementary-charge account ZK1 and the second supplementary-charge account ZK2. The charge account GK is a prepaid charge account, i.e. an account including a prepaid charge credit which the child can expend by using his communications terminal 3. The first supplementary-charge account ZK1 is a post-paid account, that is an account to which the accumulating communications charges are debited which are invoiced to a person responsible for payment when the communications link incurring the charges has been terminated. In this case, the persons responsible for payment in relation to the first supplementary-charge account ZK1 are the child's parents, that is to say the users of the destination communications terminals 5c and 5d.

The destination communications terminals 5c and 5d belong to the selection A1 of destination communications terminals. Information relating to this predetermined selection A1 is stored in the database DB. This database stores identification criteria for the destination communications terminals 5c and 5d together with a name for the selection A1. These identification features can, by way of example, be address information for the destination communications terminals 5c and 5d, e.g. their call numbers. The destination communications terminal 5c has the call number “34” and the destination communications terminal 5d has the call number “12”.

The database DB can store the predetermined selection A1 of destination communications terminals in the following form, for example:

Selection A1:

Destination communications terminal with call number “34”: account ZK1

Destination communications terminal with call number “12”: account ZK1

This data record in the database DB includes the information that the predetermined selection A1 of destination communications terminals includes the destination communications terminals with the call numbers “34” and “12”, and that the communications charges are debited to the first supplementary-charge account ZK1. These are the communications charges which arise when telecommunications links are set up from the communications terminal 3 to the two aforementioned destination communications terminals. Within the selection A1, each destination communications terminal can have a dedicated account associated with it, or the destination communications terminals in the selection can have the same account (as illustrated above) associated with them.

The database DB can likewise include a further data record having the following content:

Selection A2:

Destination communications terminal with call number “56”: account ZK2

This data record states that the predetermined selection A2 of destination communications terminals includes the destination communications terminal with the call number “56”. When communications links are set up from the communications terminal 3 (with the call number “90”) to the destination communications terminal 5b with the call number “56”, the communications charges incurred need to be invoiced using the second supplementary-charge account ZK2.

The child's communications terminal 3 will now be used to set up a communications link KV to the parents' destination communications terminal 5c. To this end, the call number “34” of the destination communications terminal 5c is dialed on the communications terminal 3 and a message N1 is sent from the communications terminal 3 to the service switching point SSP, with the message N1 possibly being routed via various other exchanges (not shown in FIG. 1). This message N1 includes, inter alia, the dialed call number “34” of the destination communications terminal 5c (the “called number” CldNo) and the call number “90” of the communications terminal 3 (the “calling number”ClgNo). The message N1 can be a message of type IAM (Initial Address Message) for example. The service switching point SSP identifies, either from the dialed address “34” of the destination communications device 5c or from the address “90” of the communications terminal 3, that a method for invoicing communications charges needs to be carried out by the service control point SCP for the communications link which is to be set up, and therefore sends a message N2 to the service control point SCP. This message N2 likewise includes the address “34” of the destination communications terminal 5c (CldNo) and the address “90” of the communications terminal 3 (ClgNo). The service control point SCP now requests from the database DB the information whether the address “34” of the destination communications terminal 5c belongs to a list stored in the database. The database returns the information that this address belongs to the list A1 and that this list A1 has the first supplementary-charge account ZK1 of the second account management facility 12 associated with it. The service control point SCP therefore debits communications charges incurred for the communications link KV to the first supplementary-charge account ZK1 of the second account management facility 12 via the transmission link 10b . The first supplementary-charge account ZK1 is thus debited with the communications charges.

If, however, the destination communications terminal 5b is called from the communications terminal 3, then the method proceeds in a similar manner to that described up to now, except for the difference that the service control point SCP receives from the database DB the information that the destination communications terminal 5b belongs to the predetermined selection A2, and that the predetermined selection A2 is associated with the second supplementary-charge account ZK2 of the third account management facility 13. Accordingly, the service control point SCP invoices the communications charges using the second supplementary-charge account ZK2 in this case.

If, in a third exemplary case, the communications terminal 3 calls a destination communications terminal 5a which is not associated with a selection, then the service control point SCP receives from the database DB, following a corresponding request, the message that the destination communications terminal 5a is not associated with a selection. The communications charges for this communications link are invoiced using the charge account GK of the first account management facility 11, since the charge account GK is used for communications links whose destination communications terminals do not belong to a predetermined selection of destination communications terminals (this information is also stored in the database DB).

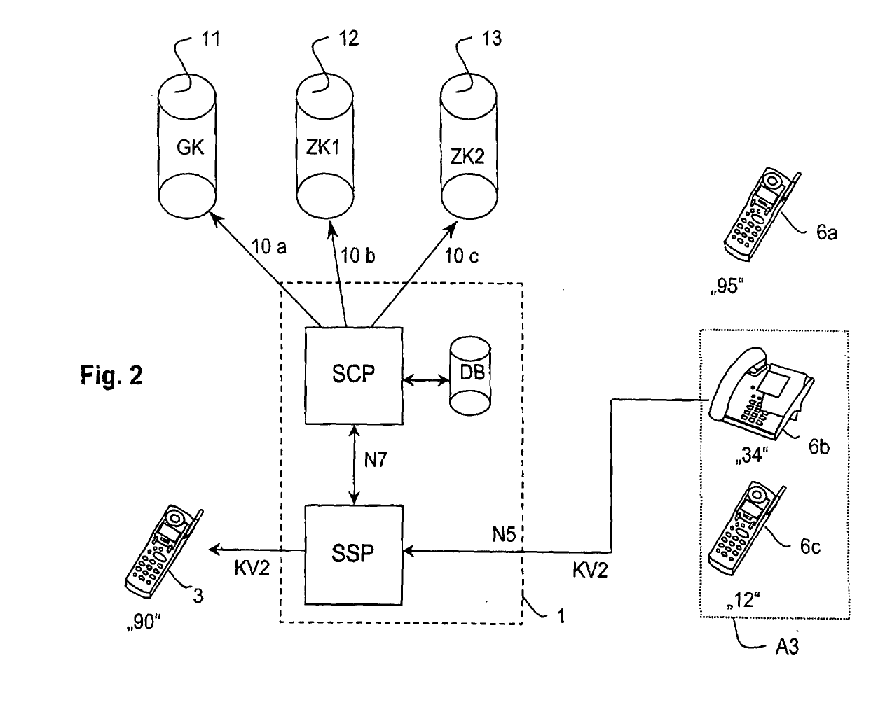

FIG. 2 differs from FIG. 1 in that, instead of the destination communications terminals 5a to 5d shown in FIG. 1, FIG. 2 shows a calling communications terminal 6a with the call number “95”, a calling communications terminal 6b with the call number “34”, and a calling communications terminal 6c with the call number “12”. The calling communications terminals 6b and 6c belong to a predetermined selection A3 of calling communications terminals. In a similar manner to that in the method described in connection with FIG. 1, this predetermined selection A3 of calling communications terminals is stored in the database DB of the communications network 1 such that, a name for the predetermined selection A3 is stored, and the call numbers, for example, of the calling communications terminals 6b and 6c are stored as identification features for the calling communications terminals 6b and 6c. In addition, the database stores the fact that the selection A3 of calling communications terminals has the associated charge account GK.

If the calling communications terminal 6b is now used to call the communications terminal 3 (a communications link KV2 is set up), the calling communications terminal 5b sends a message N5 to the service switching point SSP. This message N5 includes the telephone number “34” of the calling communications terminal 6b (as ClgNo) and the address “90 ” of the communications terminal 3 (as CldNo). In a similar manner to that in the method described in connection with FIG. 1, the service switching point SSP then sends a message N7 to the service control point SCP. This message N7 likewise includes the ClgNo and the CldNo. The service control point now reads from the database DB whether the calling communications terminal 6b with the call number “34” belongs to a predetermined selection of calling communications terminals. The database DP sends to the service control point SCP the information that the calling communications terminal 6b belongs to the predetermined selection A3 of calling communications terminals, and that the selection A3 has the associated charge account GK. The service control point SCP then uses the transmission link 10a to debit the charge account GK (associated with the communications terminal 3) of the first account management facility 11 with the communications charges incurred in connection with the communications link.

In another example, it is assumed that the calling communications terminal 6a wishes to set up a call to the communications terminal 3. In this case, the database DB sends to the service control point SCP the information that the calling communications terminal 6a does not belong to a selection of calling communications terminals. The communications charges incurred in connection with this call are then invoiced using a supplementary-charge account (not shown in the figure) specific to an external appliance, which account is associated with the calling communications terminal 6a.

In the methods described above, the occurrence of predetermined communications link properties has been identified when a calling communications terminal belongs to a predetermined selection of calling communications terminals or when a destination communications terminal belongs to a predetermined selection of destination communications terminals. Other variables can also be evaluated as communications link properties. However, it is possible to evaluate whether the communications link is set up within prescribed geographical regions (local calls, long-distance calls or international calls), whether the communications link is set up to specific chargeable services (premium rate services), whether the communications link is set up at specific times (time of day, day of the week, month, year, vacation time, public holiday, work time, free time). In that case, instead of or in addition to the predetermined selections of calling or destination communications terminals, the database DB may store, by way of example, data records including for the communications terminal 3 an association between geographical regions and charge or supplementary-charge accounts for communications links set up from this communications terminal. The data records could likewise contain associations between time or date ranges and charge or supplementary-charge accounts.

In addition, the communications link property evaluated can also be the level of the account balance of the charge account or of one of the supplementary-charge accounts. By way of example, if an account balance of a prepaid charge account has reached the value zero, the charges can be invoiced using another supplementary-charge account instead of using the prepaid charge account. In addition, the volume of calls can be evaluated in order to determine a charge account or a supplementary-charge account for invoicing the communications charges. If there is a low volume of calls, i.e. when there are not many calls per unit time, the communications charges are invoiced using a charge account, for example, but are invoiced using a supplementary-charge account when there is a high volume of calls. In addition, the method can be designed such that the length of telecommunications links set up is used to derive which charge account is debited with the communications charges. Thus, by way of example, communications charges incurred by short communications links can be debited to the charge account, while communications charges incurred by long communications links are debited to a supplementary-charge account, for example. In this case, a cheaper tariff can be used for the supplementary-charge account than for the charge account.

The exemplary embodiment described in connection with FIGS. 1 and 2, in which embodiment the communications terminal 3 is associated with a child and the destination communications terminals 5c and 5d and the calling communications terminals 6b and 6c are associated with this child's parents, has a series of advantages: when the child uses the communications terminal 3 to telephone his parents, the communications charges are invoiced using the first supplementary-charge account ZK1, which is paid for by the parents. This means that no costs are incurred for the child and he can telephone his parents irrespective of financial considerations. However, if the child makes a telephone call to another terminal, for example to the destination communications terminal 5a , which may be associated with a friend of the child, for example, the communications charges are invoiced using the charge account GK, which is the child's personal charge account, for example, and is paid for from the child's pocket money. The necessity to pay for one's own telephone calls from one's own money can thus be used to achieve an educational effect.

It will be expressly stated that this exemplary embodiment using the child/parent relationship is only one of many possible exemplary embodiments. Naturally, the communications terminal 3 can be used by any communicating party. The same also applies to the calling communications terminals and to the destination communications terminals.

What is claimed is:

1. A method for invoicing communications charges incurred when using a communications terminal, comprising:
invoicing charges using a charge account associated with the communications terminal and at least one supplementary-charge account;
evaluating the account balance of the charge account or of the supplementary-charge account, when the communications link is set up, for the respective communications link as a communications link property; and
debiting either the charge account or one of the supplementary-charge accounts is debited with the communications charges, depending on the occurrence of the communications link property.

2. The method as claimed in claim 1, wherein one of the supplementary-charge accounts used is a terminal-specific supplementary-charge account which is associated with the communications terminal.

3. The method as claimed in claim 1, wherein one of the supplementary-charge accounts used is a supplementary-charge account specific to an external appliance, which account is associated with a terminal other than the communications terminal.

4. The method as claimed in claim 1, wherein the charge account debited is a prepaid charge account.

5. The method as claimed in claim 1, wherein the supplementary-charge account used is a subsequently debitable supplementary-charge account which is debited when the communications link has been terminated.

6. The method as claimed in claim 1, wherein different charge tariffs are used for debiting the charge account and for debiting the supplementary-charge account.

7. The method as claimed in claim 1, wherein the debit to the charge account and the debit to the supplementary-charge account are borne by different cost units.

8. The method as claimed in claim 1, further comprising:
debiting the supplementary-charge account if the communications terminal is used to set up a communications link to a destination communications terminal which belongs to a predetermined selection of destination communications terminals; and
debiting the charge account if the communications terminal is used to set up a communications link to other destination communications terminals.

9. The method as claimed in claim 1, further comprising:
debiting the charge account when a communications link is set up to the communications terminal from a calling communications terminal which belongs to a predetermined selection of calling communications terminals; and
debiting one of the supplementary-charge accounts associated with the calling communications terminal when a communications link is set up to the communications terminal from another calling communications terminal.

10. The method as claimed in claim 1, wherein the communications link property the time at which the communications link is set up.

11. The method as claimed in claim 1, wherein the communications link properties are evaluated by an intelligent node in a communications network having an intelligent network structure.
